(19) United States
(12) Patent Application Publication
(10) Pub. No.: US 2018/0239836 A1
(43) Pub. Date: Aug. 23, 2018

(54) DIGITAL SEARCH FILTER THAT PRESENTS RESULTS FOCUSED ON THE MOST RELEVANT SOLUTIONS

(71) Applicant: Shocase, Inc., San Francisco, CA (US)

(72) Inventors: Ronald P. Young, Mill Valley, CA (US); David Anthony Burgess, Menlo Park, CA (US); Jonathan James Trevor, Menlo Park, CA (US); Peter Rugg, New York, NY (US)

(21) Appl. No.: 15/959,178

(22) Filed: Apr. 21, 2018

Related U.S. Application Data
(63) Continuation of application No. 14/864,248, filed on Sep. 24, 2015.
(60) Provisional application No. 62/054,493, filed on Sep. 24, 2014.

(51) Int. Cl. G06F 17/30

(52) U.S. Cl. CPC G06F 17/30964

(57) ABSTRACT

A method for answering at least one query directed by a user to a target comprises: obtaining a set of data from the target; obtaining at least a first term of a query from the user; searching within the set of data for at least the first term; categorizing the query, wherein the categorization is based at least in part on the search within the set of data for at least the first term; obtaining an initial set of one or more results for the query based at least in part on the first term; filtering the initial set of one or more results for the query based at least in part on the categorization of the query; and displaying the filtered initial set of one or more results to the user.

### CROSS-REFERENCE TO RELATED APPLICATIONS

This application is a continuation of U.S. patent application Ser. No. 14/864,248, filed Sep. 24, 2015 entitled, “DIGITAL SEARCH FILTER THAT PRESENTS RESULTS FOCUSED ONLY ON THE MOST RELEVANT SOLUTIONS,” which claims priority to U.S. Provisional Patent Application. Ser. No. 62/054,493, filed Sep. 24, 2014 entitled, “DIGITAL SEARCH FILTER THAT PROVIDES RESULTS FOCUSED ONLY ON THE MOST RELEVANT ALTERNATIVES,” which are hereby incorporated by reference herein.

This Application is also related to U.S. application Ser. No. 14/507,003, filed Oct. 6, 2014 entitled, “SYSTEM AND METHOD TO PROVIDE COLLABORATION TAGGING FOR VERIFICATION AND VIRAL ADOPTION,” which claims priority to U.S. Provisional Patent Application. Ser. No. 61/887,423, filed Oct. 6, 2013 entitled, “A SYSTEM AND METHOD TO PROVIDE COLLABORATION TAGGING FOR VIRAL VERIFICATION AND ADOPTION.”

### FIELD OF THE INVENTION

Embodiments of the present invention pertain to computer software, particularly Internet software that drives search applications, such as searches of databases or networks.

### BACKGROUND OF THE INVENTION

Social networking sites are commonly used by individuals and companies on the Internet for many different purposes. Companies, organizations, and individuals are capable of setting up profiles on these sites that include basic information, projects, awards, collaboration with others, etc. Such information can then be viewed by other registered site users, as individuals can search the social network to pull up profiles, projects and portfolios of interest.

Some social networking sites also provide searching capabilities that enable registered users to enter search criteria and receive a webpage displaying the search results. In some implementations, social networking sites may customize the search results in a manner that is amenable to a user's location or personal preferences.

It will be appreciated, however, that conventional systems and processes are structured to present the user with as many search results as possible, and do not present search result information in an optimized fashion relative to the needs of the user. As more criteria are added, conventional search engines give the user more and more results. In computer and database systems, an efficient method of searching the large volume of data is very important.

### SUMMARY OF THE INVENTION

One aspect of the present invention includes a method for processing at least one query directed by a user to a target. The method comprises: obtaining a set of data from the target; obtaining at least a first term of a query from the user; searching within the set of data for at least the first term; categorizing the query, wherein the categorization is based at least in part on the search within the structured data for at least the first term; obtaining an initial set of one or more results for the query based at least in part on the first term; filtering the initial set of one or more results for the query based at least in part on the categorization of the query; and displaying the filtered initial set of one or more results to the user.

Another aspect of the present invention includes a system for processing at least one query directed by a user to a target. The system comprises: means for obtaining a set of data from the target; means for obtaining at least a first term of a query from the user; means for searching within the set of data for at least the first term; means for categorizing the query, wherein the categorization is based at least in part on the search within the structured data for at least the first term; means for obtaining an initial set of one or more results for the query based at least in part on the first term; means for filtering the initial set of one or more results for the query based at least in part on the categorization of the query; and means for displaying the filtered initial set of one or more results to the user.

### BRIEF DESCRIPTION OF THE DRAWINGS

FIG. 1 shows a flowchart for the steps involved in a deductive search and the presentation of search results.

FIG. 2 depicts the beginning of a search for college football coach in Santa Cruz and the what is offered to the user at this first step of the process, as well as what is happening in background in order to display of the search user interface.

FIG. 3 shows the search results and process with the addition to the original query of a secondary search term.

FIG. 4 shows the search results and process with the addition to the original query of a tertiary search term.

FIG. 5 shows the search results and process as a fourth and in this example, the final search criterion is added to the query.

FIG. 6 represents an overview of the user interface that a user of the system might be presented with on his computer screen.

FIG. 7 shows a detailed breakdown of all parts of the user interface available to the user.

### DETAILED DESCRIPTION OF THE INVENTION

Embodiments of the present invention generally relate to aspects of search on internet sites that present access to structured and unstructured data. Examples of such sites include social networking site platforms, market networks, product sale, service sale and auction sites. Embodiments of the present invention include the automatic presentation of dynamically optimized search results delivering to the user the most appropriate solution available in the data set responsive to search query criteria.

Embodiments of the present invention utilize proprietary structured data sets to segregate different elements of the data set into categories of interest to the user and more efficiently reduces the output presented to the user to the limited number of results that meet all of the search criteria, thus giving the user a more efficient tool to home in on the objective target result. Embodiments of the present invention also permit the user to remove or modify one or more search criteria and immediately see a user interface that may present the same or different results.

Embodiments of the present invention include a deductive filtering search system with a graphical preview and viewing interface that focuses on the specific search result that matches all of the user's search criteria. The search method employs algorithms for determining the nature of the desired search result and the user interface presents focused results only, without superfluous items. The presentation of results gives users a more efficient route find a specific result desired.

Embodiments of the present invention may include a system that uses structured data to specifically answer a search query with results which are focused on a user's search objective based on algorithms that identify the user's search objective and which are refined with additional search criteria to present optimal results matching the search query. Additionally and/or alternatively, embodiments of the present invention may include a method to display to the user focused search results using structured data to specifically answer a search query with results focused on a user's search objective based on algorithms that identify the nature the user's search objective and that refine results with additional search criteria to present optimal results matching all the search terms.

Embodiments of the present invention may include a system that uses structured data to specifically suggest relevant additional search criteria and filters to improve the results of the search query. Additionally and/or alternatively, embodiments of the present invention may include a method to suggest relevant additional search criteria and filters using structured data to specifically answer a search query with results based on algorithms that identify the user's search objective.

In the embodiments discussed in the preceding paragraphs, the structured data may be in a social network or market network or product sale site or service sale site or auction site. The user's search objective may be identified as, for example, one or more people, organizations, projects, events, products, services or jobs.

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known entities, structures and devices are shown in block diagram form in order to avoid unnecessarily obscuring the implementations of the invention.

As will be apparent by the ensuing description and illustrations, the search user interface may be embodied as an Internet website or any combination of desktop or mobile hardware and software configured to facilitate and support efforts searching diverse data elements in a database storage or other digital storage device.

By way of review, when using social networks, market networks, product sale, service sale and auction sites, and Internet sites that present data sets of structured and unstructured data, companies, individuals, or organizations regularly create a profile that includes basic information, projects, awards, specialization data, collaboration with others, etc. There are networks that are subsets of social networks that are intended for business and commercial purposes. These networks may address the needs and interests of a specific market or business vertical. These networks for commerce are now regularly referred to as market networks. Collaborators on projects in such networks derive significant commercial benefit from the association with others on significant projects and may be tagged in the profile. Users may access the profiles of these projects, events, and postings of these collaborators. Since the power of market networking has been proven to be a successful component of business and friendship development, users are eager to provide information and update their profiles on a regular basis.

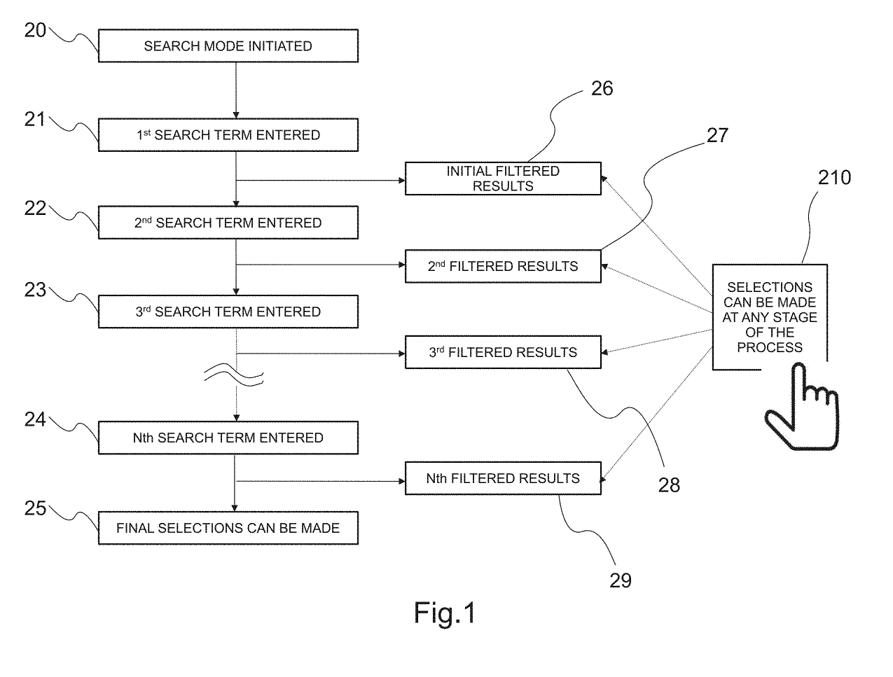

FIG. 1 presents a flow chart of the search process and how the results are filtered and displayed in real-time as further search terms are added. As each subsequent search term is entered, algorithms are applied to determine how the filtered results are displayed, and the next filters that could be applied.

When a user wants to search the database for the best person, company, organization, projects or events in a particular field, he enters search mode, 20, and starts to input search terms related to the criteria that he deems necessary for the refining of his search. The first search key word, 21 instantly offers up to the user a list of search results, 26, which are listed in order of relevance to the user. In order to determine what kind of information the user, is seeking, the search term is analyzed and compared with structured data sets applicable to the social or market network deploying the software.

Those skilled in the art of search know that search objectives can be broken into basic elements: who, what, where, why, and how or how much. The present invention utilizes structured data and analysis of the search criteria to determine whether the user is searching for a named person or entity, an object, or a location. Data, stored in social networks, and many other structured and unstructured data sets, is predominantly of the who, what, where variety. By structuring the data in this way, a focused search result can more rapidly deliver the result that is the best solution to the search. “Who” based data comes in two varieties in nearly all data set networks: the person who is a user, and the company or school or organization or other entities with which he is associated. A search key word that is a name or name-like, or hits a match on any names in the data set will be initially marked as looking for a person or entity. Certain key words will show matches in multiple areas. By way of example, Francisco can be the name of a person, or a place like San Francisco. The system algorithms can measure the incidence of occurrence as a name or a location, and make a preliminary determination on how to respond to the query. Social and market networks are predominately about the “what”, and the “who” involved in the what. The “what” may be a presentation, a contest, a creation, an event, or a project, depending on the nature of the network. The “who” are the players, creators, winners, performers, advisors, collaborators or owners. Embodiments of the present invention include software methods which compare the first key word to hits in the structured data set and allocate a preliminary designation as a who, where, or what type of query. A limited number of results are shown on the user screen but there are likely many more not shown. The top few results in the designated category are displayed, 26, and are available to be selected for more detailed viewing, 210.

It is important to note that embodiments of the present invention calculate a level of match for each search result and measure the relevance in order to determine prioritization of results. A second level of results for “who” and “what” queries can be presented based on their relevance to the first key word, 21. The first and second level results can be further focused and ranked based on location proximity to the user.

The user then types in another search term, 22, and the previous list is further pared down in real time, yielding a modified set of results, 27. At this point, the search terms are reviewed again to confirm the designation of the user's objective to have a “who”, “what”, or “where” solution to the query, and to ascertain the priority of those objectives. Priority can be determined in several ways including the order and specifics of the search terms. The number of results, 27, in the data set matching the two search terms, 21, and 22, will be fewer than the results in 26, as this is a reductive search process seeking the best solutions, not the greatest number of possible solutions. Once again these results can be looked at in more detail by selecting the profiles or other information such as projects or products on offer, 210.

By the time the third search term is added to the search field, 23, the list of profiles, entities, objects or locations, 28, is greatly filtered down. With the addition of each additional search term, there is greater assurance that the search objective becomes more distinctive, for example for a person, an organization, or information about a project, product, or event. Differentiation between persons, organizations or projects is based on the relevance of the search criteria to attributes of people, organizations and projects. People have jobs, titles, skills, and education. While organizations have industry, locations, and brand among other attributes. Projects can have title, industry, company, brand, project type, awards, segment, date, and other identifying elements. These attributes are associated with people, organizations and/or projects can vary extensively depending on the purposes for the data set, and the data embedded therein. The algorithms in the system use this structured data as well as the level of relevance of the search terms in unstructured data. Unstructured data includes free form descriptions in various parts of the data set where there is no structured name attached to the data element.

The process can continue as the user enters additional search terms until the last search term, 24, yields the desired results, 29. If the user is looking for many results that meet loose criteria, he can scan the results and suggested refining criteria after entering just a few search terms. A user who continues to enter additional refining criteria will eventually narrow the results to the search solution that best meets all of the combined search terms. Search terms need not merely be separated by spaces or commas, in other embodiments of the system, search terms can be separated by conjunctions such as “or”, “and”, “not” in order to widen or narrow the scope of alternatives for which the ultimate optimal solution is sought.

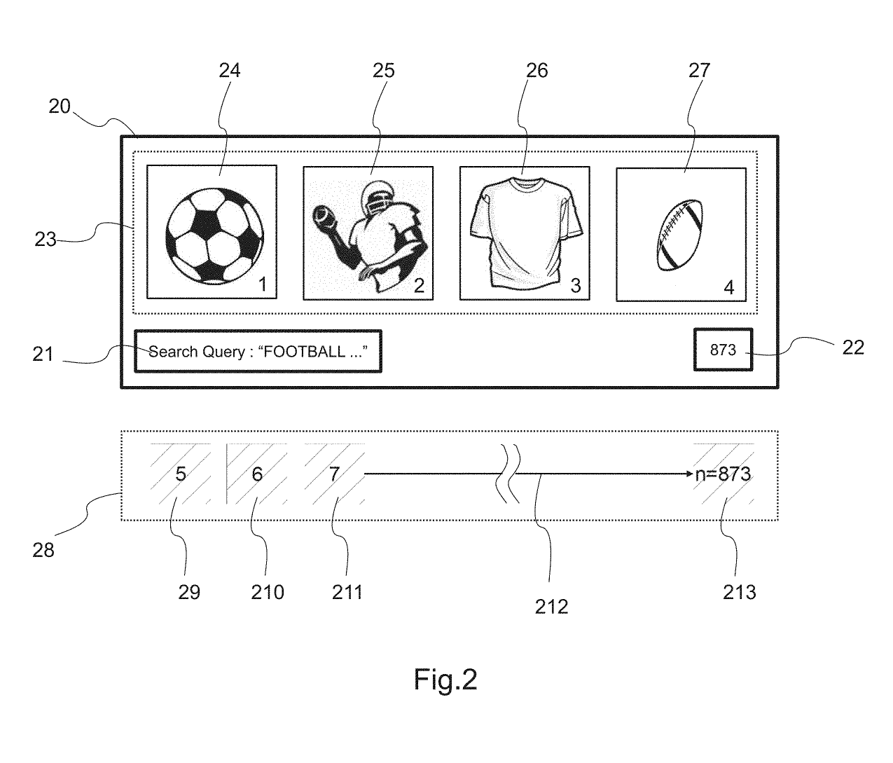

In one embodiment of the invention, a user wishes to search for college football coaches in the Santa Cruz area. FIGS. 2 to 5 show the progressions of such a search and both what is presented to the user on the screen and what is going on behind the scenes.

FIG. 2 represents the initial search term “football” entered into the search field, 21 and the results that that yields both on, 20, and off, 28, the user's screen. When the word “football” is typed into the query field, 21, in this example, the algorithms in the system would score a low relevance for the name of a person or for a location, and a higher relevance for and event, job, or organization, based on occurrences in the data set. While a total of 873 results as indicated by the results counter, 22, are returned in real-time, what is visible to the user, as represented by the outlined area, 20, is a handful of the top search results arranged in order of most relevance. An international football, 24, has highest relevance. Other highly relevant results include a person playing football, 25, a uniform object, 26, and an American football, 27. The remaining vast majority of search results which is initially invisible to the user is outlined separately, 28. As can be seen a great number of unseen results are available, 29, 210, 211, many more as represented by 212, all the way up to the n^{th} result, 213. Any of these initially unseen results can be brought into play by scrolling down the screen where any of them can then be selected for further detailed inspection. Front and foremost on the screen is an area, 23, dedicated to showcasing the top results.

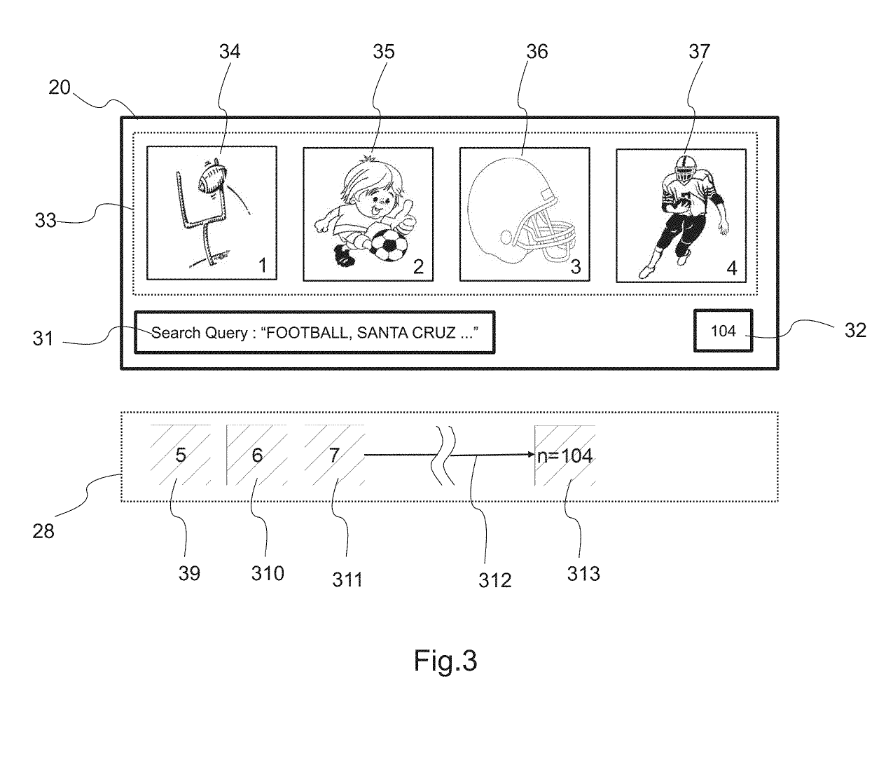

FIG. 3 the next search term is input so that the search field now reads “Football Santa Cruz” and the search results immediately reconfigure to include the identifiable location term “Santa Cruz” once again show the top most relevant, 33, while filtering, and therefore reducing, the original larger list of results. The new total is now displayed as 104 as shown in the results tally field, 32.

Top results, 33, now include a Santa Cruz football field, 34, a soccer school for children, 35, a sports shop in the Santa Cruz area, 36, and a local football league, 37. As before, the remaining off-screen results, 28, can be brought into view by scrolling down to them. These additional results are shown to have been reduced in number as indicated by 39, 310, 311 via 312 to 313.

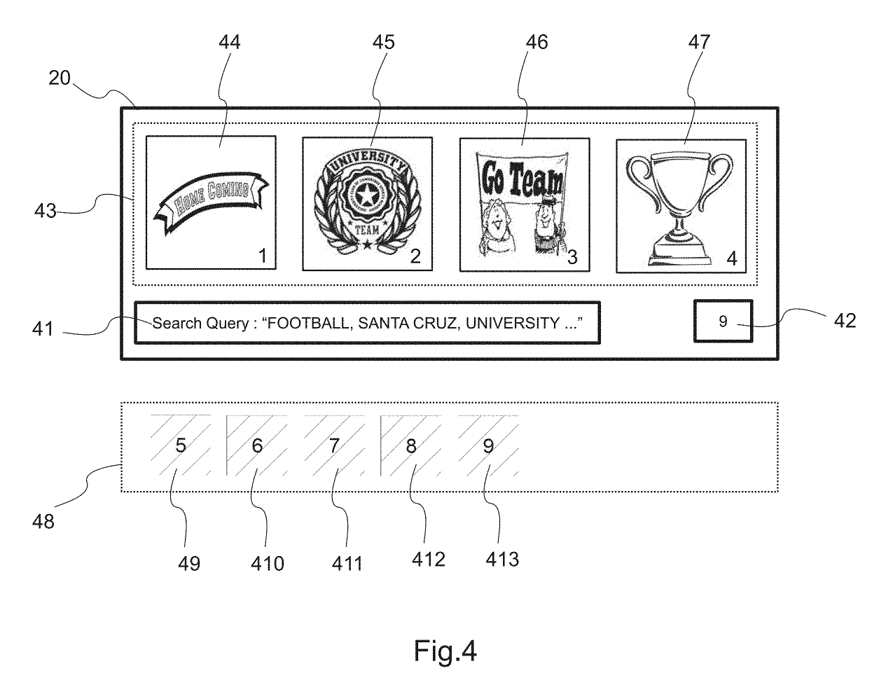

FIG. 4 shows how the search narrows much further when the word “university” is added to the search, 41. “University” is identifiable in the search term relevance algorithms as an organization reference. Now the results list is further reduced to a total of 9 items as shown in the results tally, 42. The top ranking finds are now very much focused in on the request and include a college home coming event organization, 44, the local university football team profile, 45, a merchandise shop for team fans, 46, and a college football association, 47. Remaining less relevant results, 48, are available by scrolling down the screen and now include just five additional items, 49, 410, 411, 412 and 413.

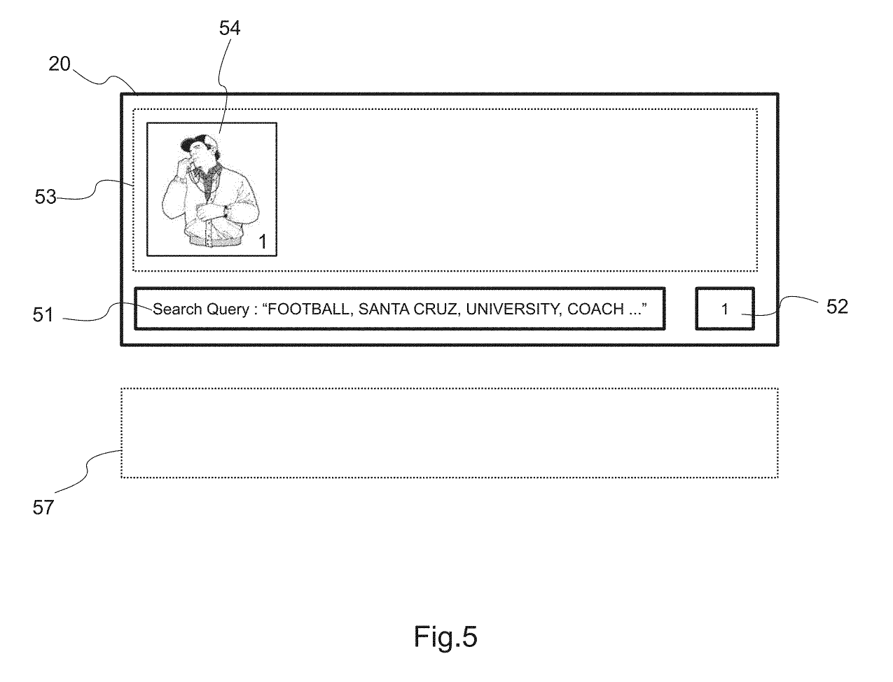

FIG. 5 shows the final stage of the search process. The word “coach”, a term with high relevance to a person, or a job, and with lower relevance as a vehicle, is added to the search, 51, and at this stage the results are narrowed down to a total of just one, 52, most relevant item and the optimum search result. The results show, 54, is the profile of a college football coach. At this point, the user has discovered the most highly focused search solution in the data set.

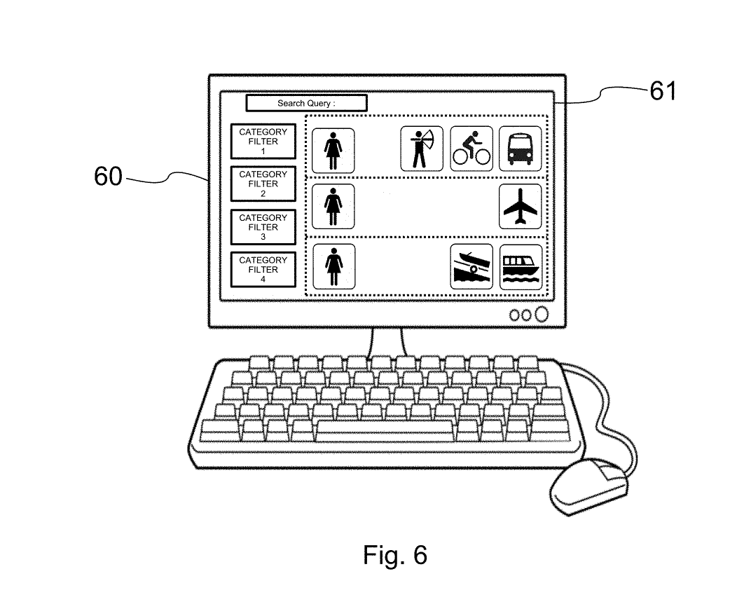

FIG. 6 shows an overview of the unique user interface, 61 that a user would be presented with on his computer screen, 60. The user is presented with a search input field at the top, a selection of search filtering options on the left hand side and the instantly-filtered search results in the main body of the screen. Here the user can browse profile previews and glean basic profile information as well as see a selection of projects associated with the profiles.

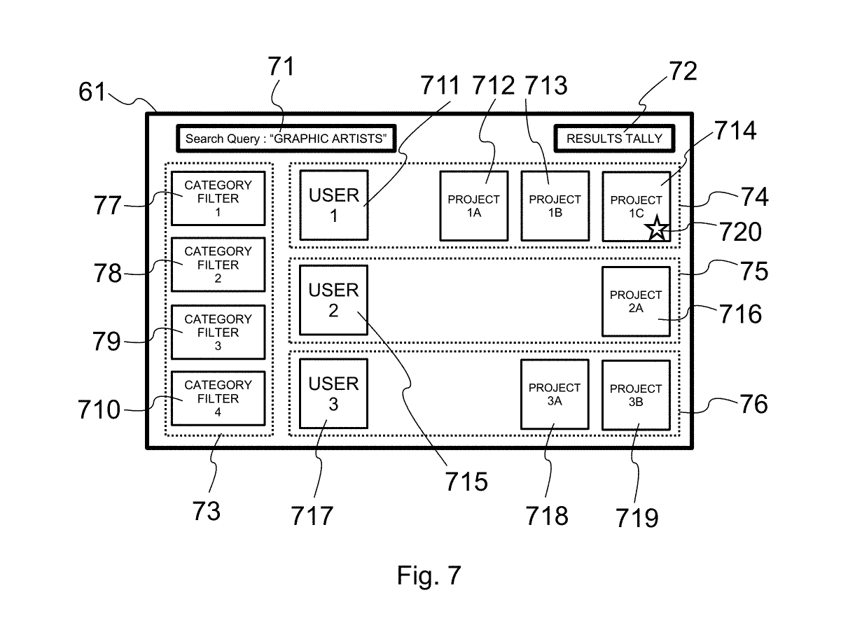

FIG. 7 shows in much greater detail the elements that make up the search interface, 61. In the embodiment shown in here a user has typed the search string “advertising writer New York TV” into the search field at the top, 71, and has been presented with a list of profiles, 74, 74 & 76.

The top rated profile, 74, shows a preview of the profile including a picture and brief summary of who they are, 711 and to the right of that a thumbnail preview selection of their finest work, Project 1A, 712, Project 1B, 713, and Project 1C, 714, which has won an award, 720. This gives the user conducting the search an excellent overview of the profile by being presented with a brief biography including his most relevant work to date, some of which have won awards. The second search result, 75, shows their profile picture and brief bio, 715, along with their most relevant project, Project 2A, 716. Finally below that is the third result, 76, this time showcasing their profile summary, 717, and Project 3A, 718 and Project 3B, 719. The total list pulled in from this search query can be further tailored by selecting from various filter checkboxes on the left of the screen, 73. Here, elements of the profiles thus far found are sorted by kind and offered for selection to be filtered. In this example, Category Filter 1, 77, is a location filter and offers the user a chance to ignore or include all profiles in the search results that are tagged with a particular location. These locations are taken from the location tags found within the search results and listed in order of most common. Other filter fields might include industry, 78, company, 79, brand, 710, and many more.

Embodiments of the present invention include methods and/or systems which utilize sophisticated algorithms to measure relevance of certain search terms to different types of results available in the data set. These algorithms increase the reliability of the prioritization of search results to focus on optimum match with the user criteria.

1. A method for answering at least one query directed by a user to a target, the method comprising:
obtaining a set of data from the target;
obtaining at least a first term of a query from the user;
searching within the set of data for at least the first term;
categorizing the query, wherein the categorization is based at least in part on the search within the set of data for at least the first term;
obtaining an initial set of one or more results for the query based at least in part on the first term;
filtering the initial set of one or more results for the query based at least in part on the categorization of the query; and
displaying the filtered initial set of one or more results to the user.

2. The method of claim 1, wherein the target comprises a database.

3. The method of claim 1, wherein the target comprises a web site.

4. The method of claim 3, wherein the website comprises at least one of a social network, a market network, a product sale site, a service sale site, and an auction site.

5. The method of claim 1, wherein the set of data from the target comprises structured data.

6. The method of claim 5, wherein the set of data from the target further comprises unstructured data.

7. The method of claim 1, wherein categorizing the query comprises:
based at least in part on the search for the first term within the set of data, categorizing at least the first term by assigning at least the first term to at least a given one of a predefined set of categories; and
based at least in part on the categorization of at least the first term, categorizing the query by assigning the query to at least the given one of the predefined set of categories.

8. The method of claim 7, wherein the predefined set of categories comprises name, object, and location.

9. The method of claim 7, wherein the predefined set of categories comprises who, what, and where.

10. The method of claim 9, wherein the predefined set of categories further comprises why, how, and how much.

11. The method of claim 7, wherein the predefined set of categories comprises person and at least one of organization and entity.

12. The method of claim 11, wherein the predefined set of categories further comprises at least one of project, event, product, service and job.

13. The method of claim 1, wherein filtering the initial set of one or more results for the query based at least in part on the categorization of the objective of the query comprises:
categorizing at least a given result within the initial set; and
retaining the given result within the filtered set only if the categorization of the given result matches the categorization of the query.

14. The method of claim 1, wherein displaying the filtered initial set of one or more results to the user comprises arranging the displayed filtered initial set of one or more results in order by relevance.

15. The method of claim 1, further comprising:
obtaining at least a second term of a query from the user;
searching for at least the second term within the set of data;
categorizing the query, wherein the categorization is based at least in part on the search within the set of data for at least the first term and for at least the second term;
obtaining a revised set of one or more results for the query based at least in part on the initial set of one or more results and the second term;
filtering a revised set of one or more results for the query based at least in part on the categorization of the query; and
displaying the filtered revised set of one or more results to the user.

16. The method of claim 15, wherein obtaining a revised set of one or more results for the query based at least in part on the first term and the second term comprises a reductive search such that each of the revised set of one or more results matches the first term and the second term.

17. The method of claim 15, wherein the second term of the query is suggested to the user based at least in part on the first term of the query.

18. The method of claim 15, wherein the second term of the query is suggested to the user based at least in part on the search within the set of data for at least the first term.

19. The method of claim 15, wherein categorizing the query comprises categorizing the query by assigning the query to at least a given one of a predefined set of categories based at least in part on a relevance of each term of the query to one or more attributes of at least the given one of the predefined set of categories.

20. A system for answering at least one query directed by a user to a target, the system comprising:
means for obtaining a set of data from the target;
means for obtaining at least a first term of a query from the user;
means for searching within the set of data for at least the first term;
means for categorizing the query, wherein the categorization is based at least in part on the search within the set of data for at least the first term;
means for obtaining an initial set of one or more results for the query based at least in part on the first term;
means for filtering the initial set of one or more results for the query based at least in part on the categorization of the query; and
means for displaying the filtered initial set of one or more results to the user.
